(19) United States
(12) Patent Application Publication
(10) Pub. No.: US 2009/0298658 A1
(43) Pub. Date: Dec. 3, 2009

(54) Power Tool Driver

(76) Inventor: Jack Yeh, Rochester Hills, MI (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/127,047

(22) Filed: May 27, 2008

(51) Int. Cl. B23Q 3/155; B23Q 5/02; B23Q 5/28; B23Q 3/00

(52) U.S. Cl. 483/14; 173/216; 173/217; 483/20

(57) ABSTRACT

A power tool driver includes a tool magazine having a cartridge that enables a change of tools in the power tool driver done in a convenient and safe way. The cartridge is selectively moveable and having a plurality of slots for accommodating a plurality of tools respectively, in which one of the tools can be selected to incorporate with the power tool driver.

### BACKGROUND OF THE INVENTION

1. Field of the Invention

The present invention relates to an improved power tool driver, in particular to a power tool that is adapted to accommodate a plurality of tools and the change of tools can be done in a convenient and safe way.

2. Description of the Related Art

Most commonly, a power tool driver has a key used for tightening or loosening a tool used with the power tool driver. But tightening and loosening operation of the key can often be time-consuming and laborious. Further, it would be very inconvenient if the key were lost.

To mitigate this problem, U.S. Pat. Nos. 5,913,524 to Barton and 6,007,071 to Middleton disclose a chuck of keyless type. Unfortunately, a disadvantage of this chuck is that the chuck held by hand can rub against the hand when tightening to or loosening the tool from the chuck.

The present invention is, therefore, intended to obviate or at least alleviate the problems encountered in the prior art.

### SUMMARY OF THE INVENTION

Accordingly, the present invention includes a power tool driver that is adapted to accommodate a plurality of tools and the change of tools can be done in a convenient and safe way.

The power tool driver includes a driving mechanism and a tool magazine housed inside the power tool driver. The tool magazine includes a tube, a cap and a cartridge which is selectively turnable and has a plurality of slots for accommodating a plurality of tools respectively. A chuck is connected to an end of the tube. The power tool driver may further comprise a clutch mechanism selectively engagable with the chuck such that the chuck can be prevented from rotation when the clutch mechanism is engaged with the chuck.

It is one aspect of the present invention that one of the tools moves out of the allocated slot, passes the cap and through the tube, and held in the chuck when the power tool driver is tilted downward.

It is another aspect of the present invention that the cartridge defines a plurality of voids that correspond to the plurality of slots and that each void permits a user to see a portion of tool received in each slot.

It is still another aspect of the present invention that the cartridge has a portion disposed outside the power tool driver such that the void permits the portion of the tool to be viewable.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a perspective view of a power tool driver in accordance with a first embodiment of the present invention, with the power tool driver includes a housing and a trigger shown in phantom.

FIG. 2 is an exploded perspective view of the power tool driver of FIG. 1.

FIG. 3 is a side view, partially in section, of the power tool driver of FIG. 1.

FIG. 4 is a side, partially in section, of the power tool driver of FIG. 1, with the power tool driver being tilted downward and with a tool inside the power tool driver being moved toward a chuck of the power tool driver.

FIG. 5 is a cross-sectional view taken along line 5-5 of FIG. 3.

FIG. 6 is a cross-sectional view taken along line 6-6 of FIG. 4.

FIG. 7 is a side, partially in section, of the power tool driver of FIG. 1, with the tool being disposed in the chuck of the power tool driver.

FIG. 8 is a side, partially in section, of the power tool driver of FIG. 1, with the tool being secured in the chuck of the power tool driver.

FIG. 9 is a perspective view of a power tool driver in accordance with a second embodiment of the present invention, with the power tool driver includes a housing and a trigger shown in phantom.

FIG. 10 is an exploded perspective view of the power tool driver of FIG. 9.

FIG. 11 is a side view, partially in section, of the power tool driver of FIG. 9.

FIG. 12 is a side, partially in section, of the power tool driver of FIG. 9, with the tool being disposed in the chuck of the power tool driver.

FIG. 13 is a side, partially in section, of the power tool driver of FIG. 9, with the tool being secured in the chuck of the power tool driver.

### DETAILED DESCRIPTION OF THE PREFERRED EMBODIMENT

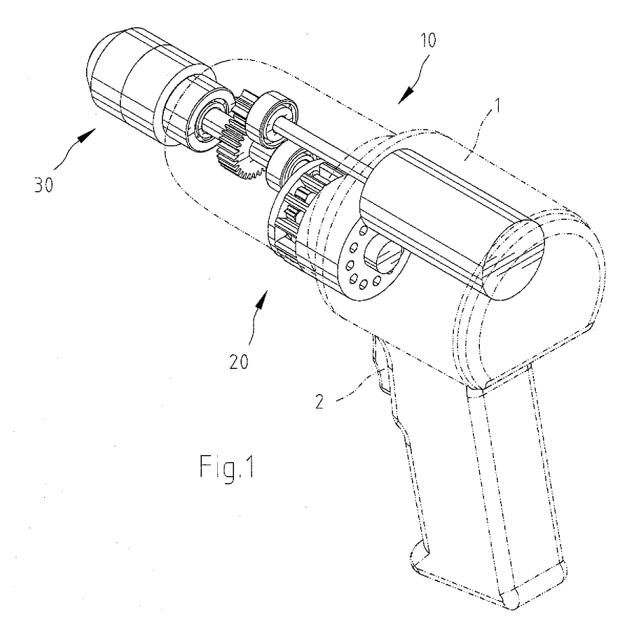

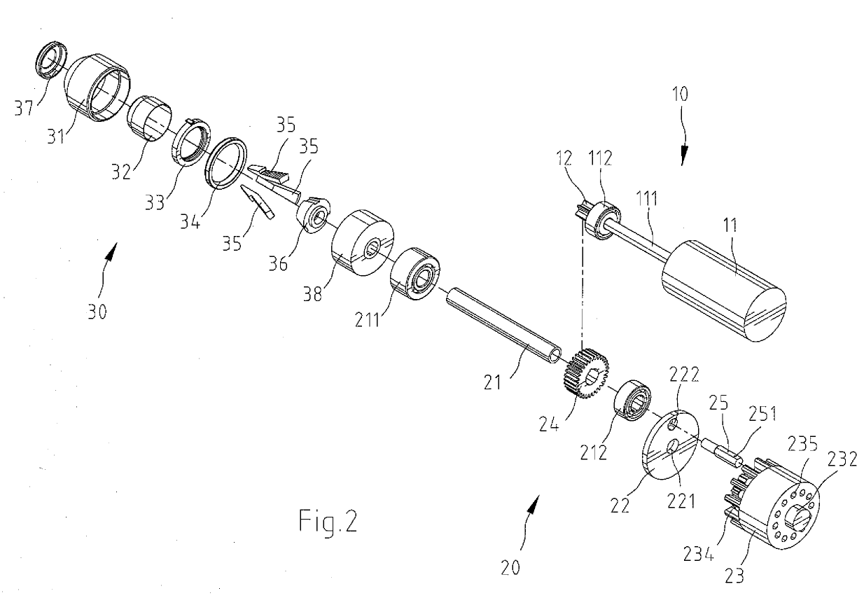

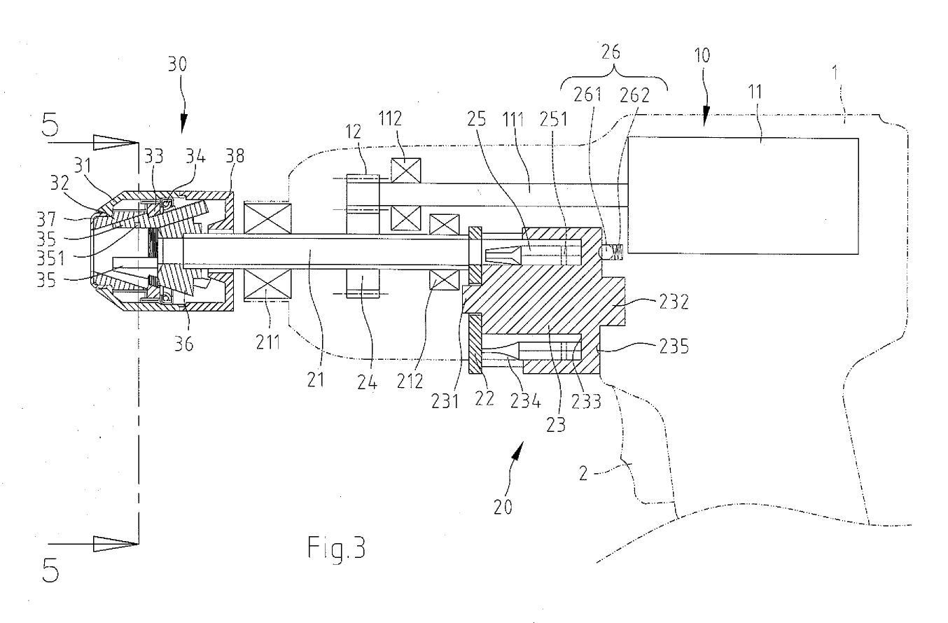

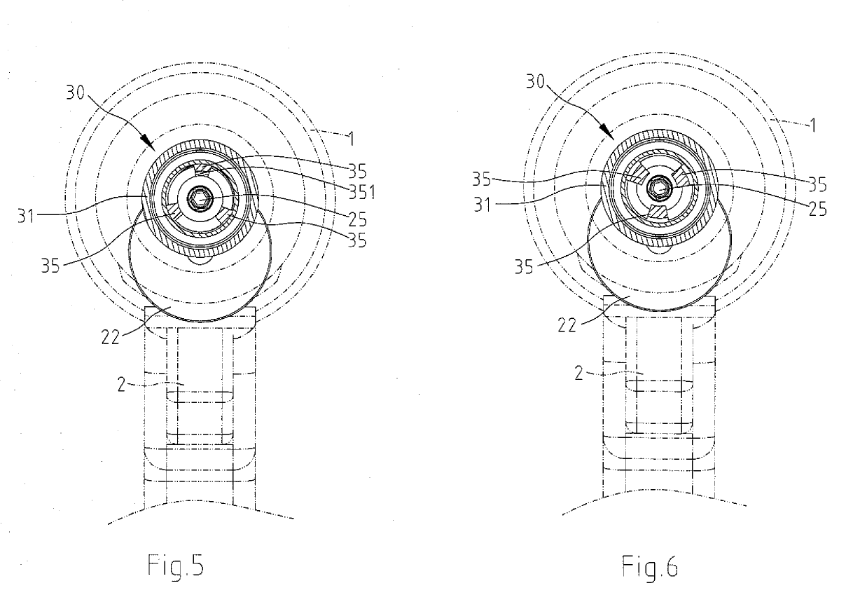

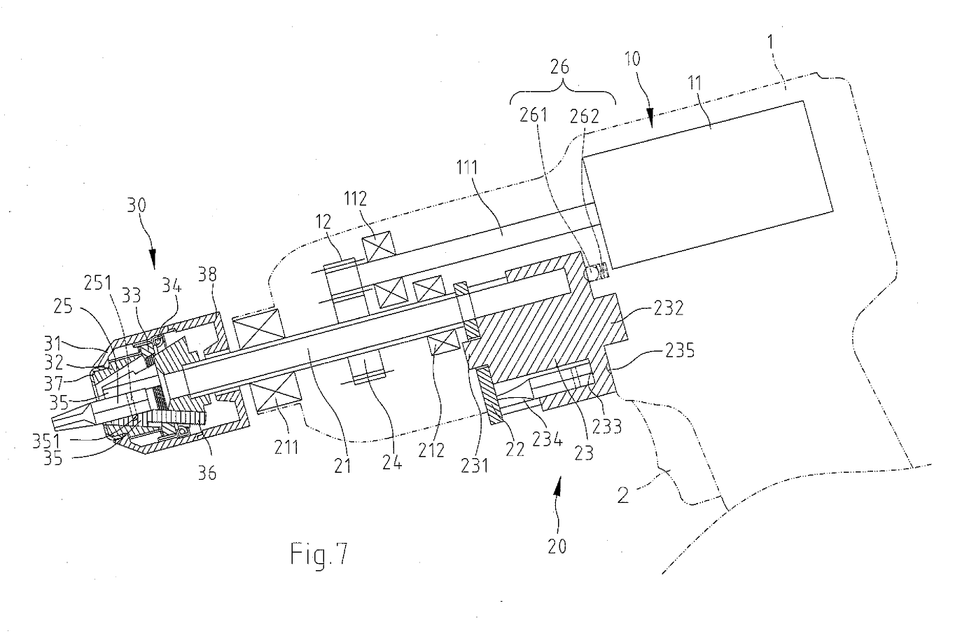

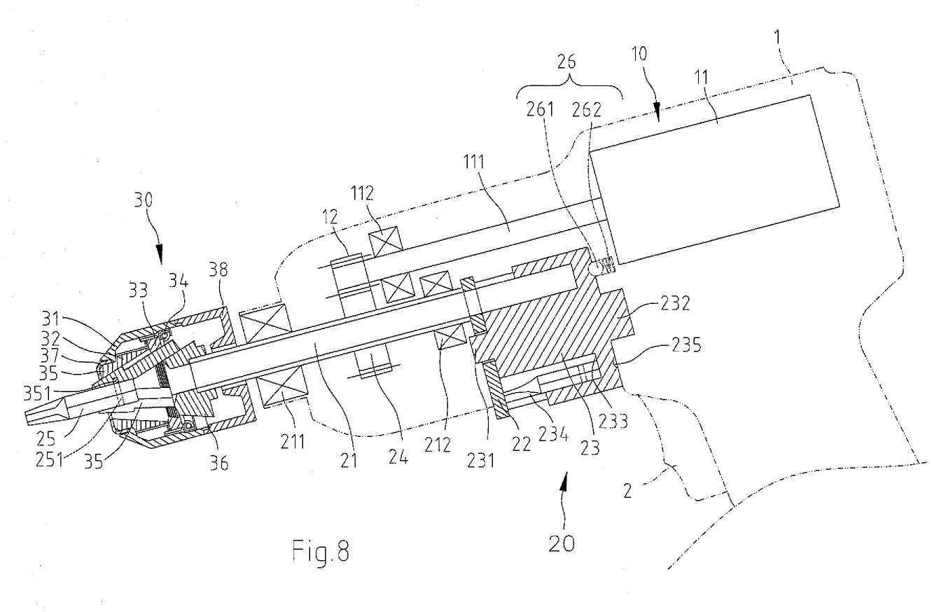

Referring to FIGS. 1 through 8, a power tool driver 1 in accordance with a first embodiment of the present invention includes a housing for accommodating a driving mechanism 10 and a tool magazine 20, and a chuck 30 connected thereto and disposed outside the housing. The driving mechanism 10 serves to operably power the power tool driver 1. In this embodiment, the driving mechanism 10 includes a motor 1 and a shaft 111 extended therefrom to connect to a gear 12. The motor 11 may be an electric motor. Alternatively, the motor 11 may be a pneumatic motor. The driving mechanism 10 may further include a lubricated support 112 for facilitating movement of the shaft 111.

The tool magazine 20 is disposed adjacent to a side of the driving mechanism 10 and includes a tube 21 being supported by lubricated supports 211 and 212 and coupled to a gear reduction mechanism. In this embodiment, the gear reduction configuration includes a gear 24 disposed on the outer periphery thereof circumferentially, and with the gear 24 being passively driven by the gear 12. However, the gear reduction mechanism is not limited to such a configuration. The tool magazine 20 further includes a preferably disc-shaped cap 22 having a first hole 221 disposed in the center thereof and a second hole 222 eccentrically disposed. The tool magazine 20 further has a cartridge 23 having a first protrusion 231 centrally disposed and pivotally received in the hole 221 of the cap 22 and a second protrusion 232 centrally disposed and pivotally fitted in the housing. In this embodiment, the second protrusion 232 has a diameter larger than that of the first protrusion 231 so that the second protrusion 232 will not be mistakenly disposed in the hole 221. The cartridge 23 further includes a plurality of slots 233 that are eccentrically disposed and that partially receive a plurality of tools 25, respectively. Specifically, the shank of the tool 25 is received in the slot 233 and the head of the tool 25 is disposed outward of the slot 233 and the head can be viewable through a void 234 and since the cartridge 23 is not completely disposed in the housing the void 234 can allow the head of the tool to be viewable outside the housing.

Figures also show that the cartridge 23 includes a plurality of indentations 235 corresponds to the plurality of slots 233 with respect to quantity as well as position and a detent 26 that can selectively dispose in one of the plurality of slots 233. In this embodiment, the detent 26 is comprised of a steel ball 261 and a spring 262. However, the detent 26 is not limited to such a configuration. When the detents 26 are received in one of the indentations 235, the corresponding slot 233 is in communication with the second hole 222 of the cap 22 and the inside of the tube 21.

The chuck 30 includes a body 36 connected to and moved by the tube 21. The body 36 has passageways that can accommodate jaws 35. Each jaw 35 is equally separated. The axes of the passageway and the jaws 35 are angled with respect to the chuck axis and can intersect the chuck axis at a common point ahead of the body 36. Each jaw 35 has a tool engaging portion (not numbered), which is substantially parallel to the axis of the body, and threads on its opposite or outer surface. Further, the engaging portion of each jaw 35 may include a magnet 351 that can cooperate with a magnet 251 included in the tool 25 and that provides the jaw 35 enhanced grips on the tool 25. The chuck 30 further includes a nut 33 in the shape of a ring and the nut 33 includes threads for mating with threads on the jaws 35. Therefore, as the body 36 is rotated by the tube 21, the jaws 35 will be caused to advance or retract with respect to the body 36. The chuck 30 further includes a bearing 34 in the shape of a ring, a sleeve 32 and an outer shell 31 to house the sleeve 32, the nut 33, the bearing 34, jaws 35 and the body 36. In addition, a forward seal cap 37 and a rearward seal cap 38 are provided at the forward end and the rearward end of the outer shell 31.

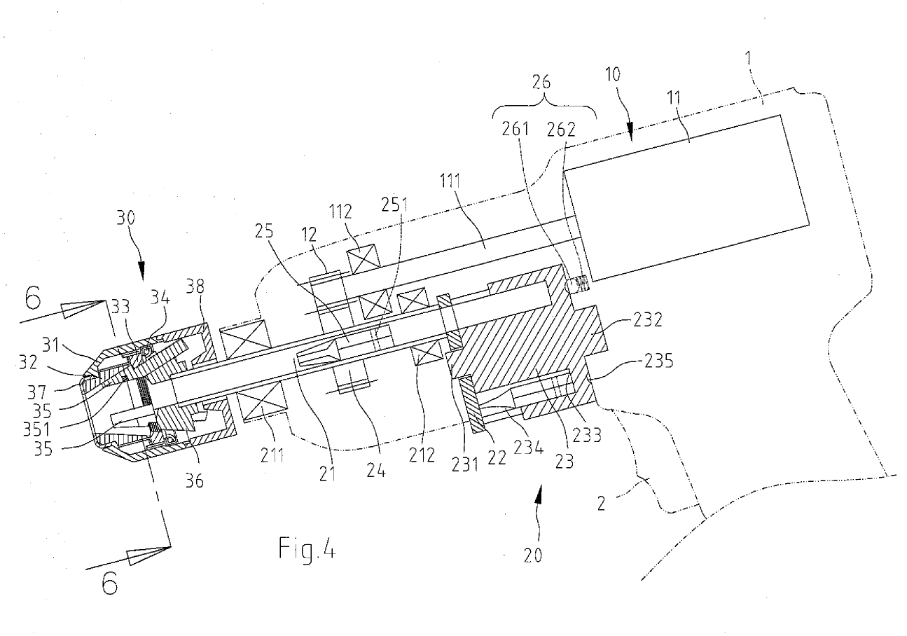

In use of the power tool driver 1, the power tool driver 1 is tilted downward (as shown in FIGS. 4, 7 and 8) to allow the selected tool 25 to move out of the associated slot 233, pass the second hole 222, and through the tube 21 automatically and be held by the engaging portions of the jaws 35 magnetically. The jaws 35 would then be gradually advanced (as shown in FIGS. 4 and 5) to securely clamp the tool 25 between the jaws 35. The advance of the jaws 35 are advanced by pressing a trigger 2 of the power tool driver 1. When finish using the tool 25, the jaws 35 could then be gradually retracted to allow the tool 25 to be released from the jaws 35. Then, the tool 25 could be pushed into the tube 21 and by tilting the power tool driver 1 upward, the tool 25 can be automatically moved into its originally allocated slot 233. When using another tool 25, the cartridge 23 is rotated, and the above procedure is repeated. Further, although not shown but it should be appreciated that one of ordinary skill would understand that the power tool driver 1 of the present invention is adapted to receive the tool 25 externally.

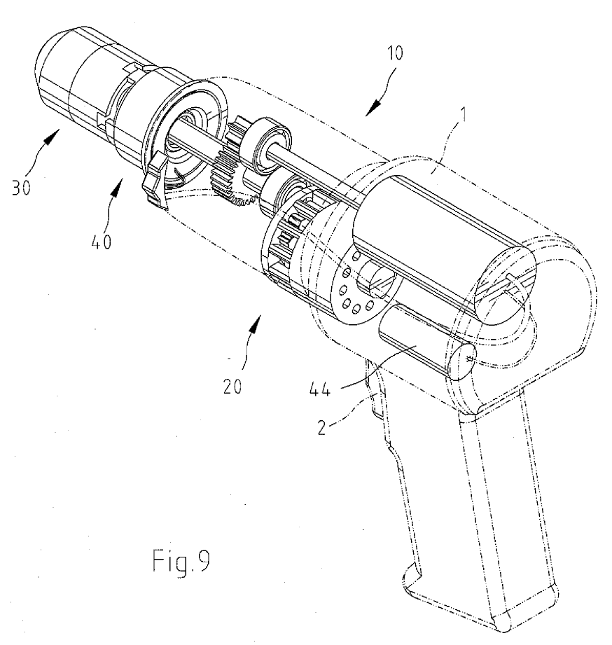

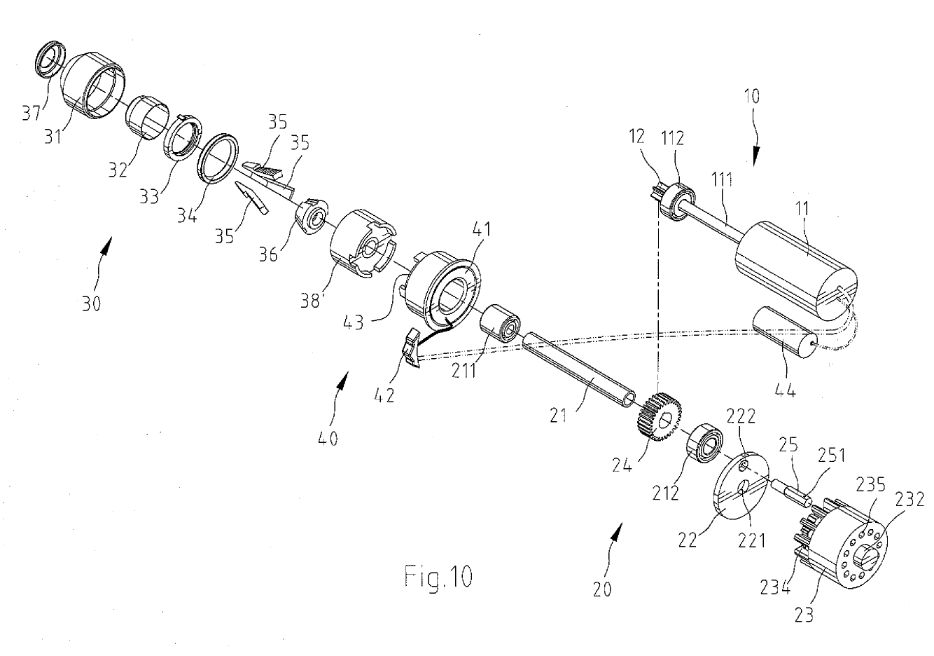

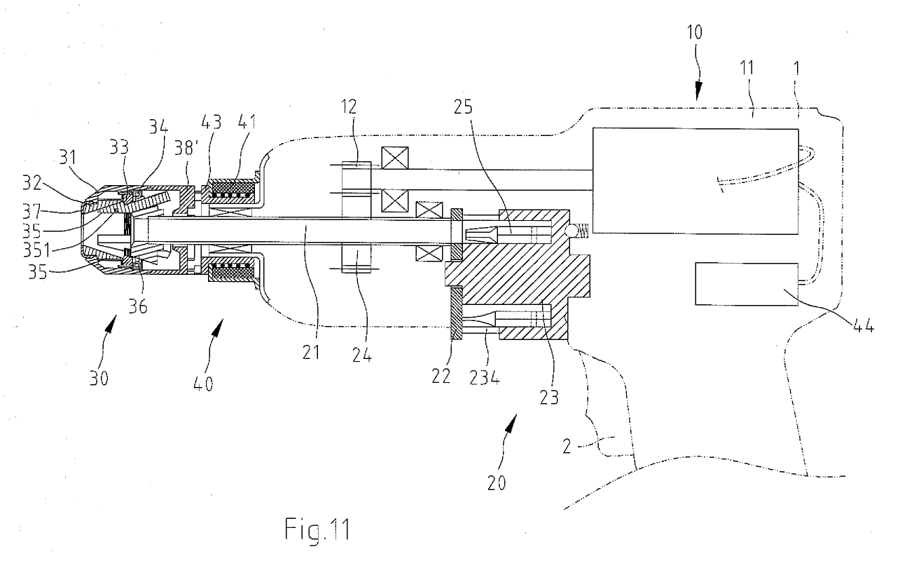

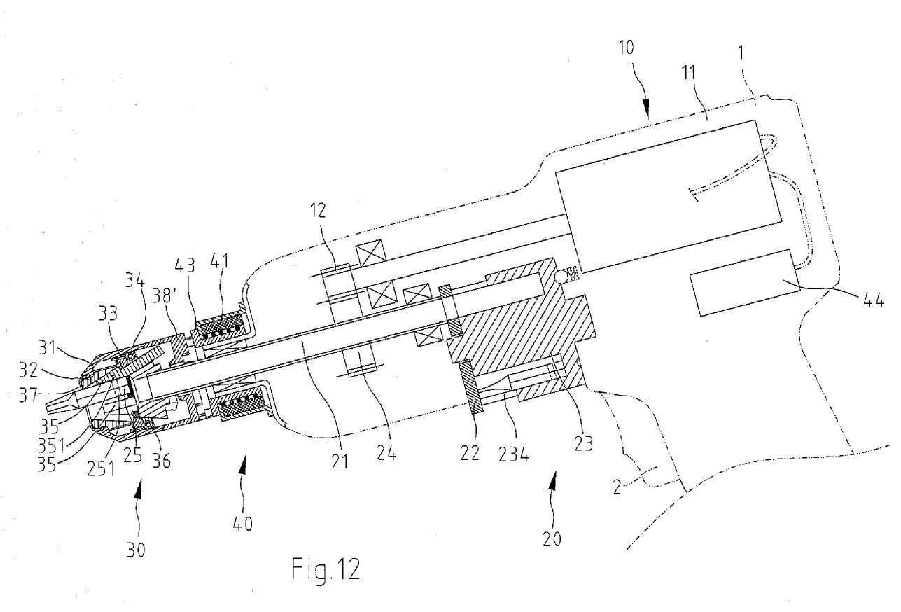

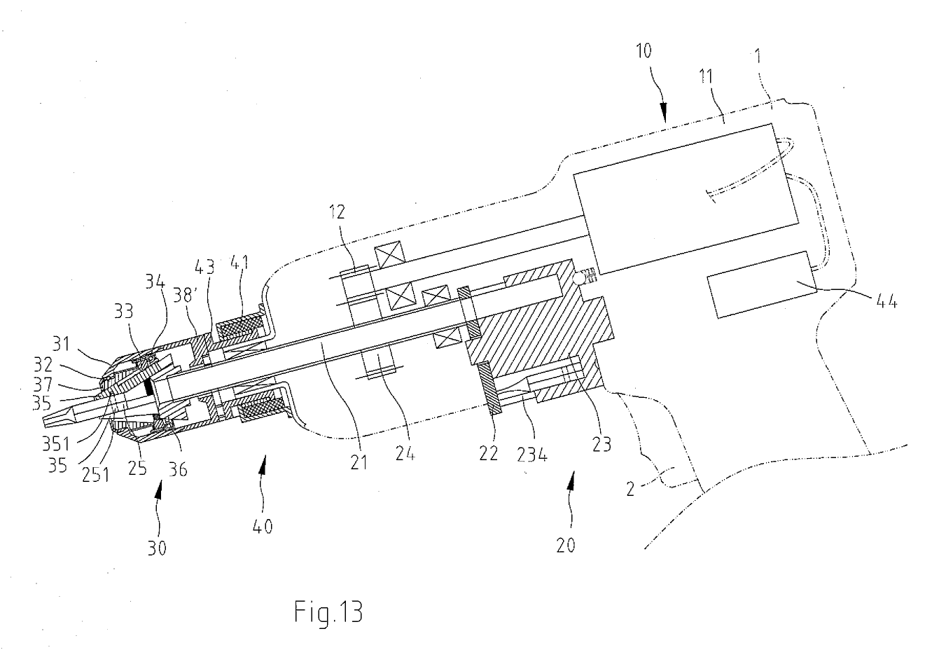

FIGS. 9 through 13 show a power tool driver 1 in accordance with a second embodiment of the present invention. This embodiment is similar to the prior embodiment except that it includes a clutch mechanism 40 that is adapted to selectively engage with the chuck 30 such that the chuck 30 can be prevented from rotation when the clutch mechanism 40 is engaged with the chuck 30. The clutch mechanism 40 includes a magnet winding 41, a switch 42 electrically connected between the magnet winding 41 and the motor 11, a piston 43 axially movable by the magnet winding 41 and a current sensor 44 electrically connected to the motor 11. Further, the embodiment includes a rearward seal cap 38′ that has a plurality of recesses. Preferably, the plurality of recesses are equally spaced and the axes of the recesses are parallel with rearward seal cap axis.

Switch 42 could not only be used to control the magnet winding 41 but to actuate the motor 11 and to cause the motor 11 to change direction of rotation.

Piston 43 includes a plurality of protrusions that can engage with the recesses of the rearward seal cap 38′, respectively, when the clutch mechanism 40 is engaged with the chuck 30. Alternatively, the piston 43 may includes a plurality of recesses while the rearward seal cap 38′ may include a plurality of protrusions.

Current sensor 44 could cause the cutoff of the current if the sensor 44 detects an instant build up of the current, which is likely to occur when the tool 25 is securely clamped between the jaws 35 and an instant decrease of the current, which is likely to occur when the tool 25 is released from the jaws 35.

While the specific embodiments have been illustrated and described, numerous modifications come to mind without significantly departing from the spirit of invention and the scope of invention is only limited by the scope of accompanying claims.

What is claimed is:

1. A power tool driver comprising:
a driving mechanism for providing power to the power tool driver;
a tool magazine including a tube, and a cartridge having a plurality of slots for accommodating a plurality of tools respectively, with the cartridge being turnable and one of the slots being alligned with the tube for allowing one of the tools to move into the tube; and
a chuck connected to the power tool driver for clamping one of the tools incorporated with the power tool driver when in use of the power tool driver.

2. The power tool driver as claimed in claim 1 further comprising a clutch mechanism selectively engagable with the chuck.

3. The power tool driver as claimed in claim 2 wherein the clutch mechanism comprises a magnet winding, a switch electrically connected between the magnet winding and the driving mechanism, a piston axially movable by the magnet winding and a current sensor electrically connected to the driving mechanism.

4. The power tool driver as claimed in claim 3 further comprising a rearward seal cap, and wherein the piston is engagable with the rearward seal cap.

5. The power tool driver as claimed in claim 1 wherein the driving mechanism comprises a motor and a gear reduction mechanism incorporated between the motor and the tube.

6. A tool magazine designed for use with a power tool driver comprising:
a tube;
a cap; and
a cartridge having a plurality of slots for accommodating a plurality of tools respectively, with the cartridge being turnable and one of the slots being alligned with the tube for allowing one of the tools to move into the tube.

7. The tool magazine as claimed in claim 6 wherein the cap comprises a hole for allowing one of the tools in the allocated slot to move through.

8. The power tool driver as claimed in claim 1 wherein the cap comprises a hole for allowing one of the tools in the allocated slot to move through.

9. The tool magazine as claimed in claim 6 further comprising a detent, and wherein the cartridge comprises a plurality of indentations corresponding to the plurality of slots with respect to quantity as well as position, and wherein the detent is selectively positioned in one of the plurality of slots.

10. The power tool driver as claimed in claim 1 further comprising a detent, and wherein the cartridge comprises a plurality of indentations corresponding to the plurality of slots with respect to quantity as well as position, and wherein the detent is selectively positioned in one of the plurality of slots.

11. The tool magazine as claimed in claim 9 wherein the detent comprises a steel ball and a spring.

12. The power tool driver as claimed in claim 10 wherein the detent comprises a steel ball and a spring.

13. The power tool driver as claimed in claim 1 wherein the cartridge defines a plurality of voids corresponding to the plurality of slots, with each of the plurality of voids permitting a user to see a portion of tool received in each slot, and wherein the cartridge has a portion disposed outside the power tool driver such that the void permits the portion of the tool to be viewable outside the power tool driver.

14. The tool magazine as claimed in claim 6 wherein the cartridge defines a plurality of voids corresponding to the plurality of slots, with each of the plurality of voids permitting a user to see a portion of tool received in each slot, and wherein the cartridge has a portion disposed outside the power tool driver such that the void permits the portion of the tool to be viewable outside the power tool driver.

15. The power tool driver as claimed in claim 1 wherein the chuck comprises a body connected to and moved by the tube, the body has passageways, jaws that can be accommodated in the passage ways, a nut having threads for mating with threads on the jaws, a sleeve, a bearing and an outer shell housing the sleeve, the nut, the bearing, jaws and the body.

16. The power tool driver as claimed in claim 2 wherein the chuck comprises a body connected to and moved by the tube, the body has passageways, jaws that can be accommodated in the passage ways, a nut having threads for mating with threads on the jaws, a sleeve, a bearing and an outer shell housing the sleeve, the nut, the bearing, jaws and the body.

17. The power tool driver as claimed in claim 15 wherein the chuck comprises jaws having a tool engaging portion having a magnet.

18. The power tool driver as claimed in claim 16 wherein the chuck comprises jaws having a tool engaging portion having a magnet.

19. The power tool driver as claimed in claim 1 wherein the slots are eccentrically disposed.

20. The tool magazine as claimed in claim 6 wherein the slots are eccentrically disposed.
